(19) United States
(12) Patent Application Publication
(10) Pub. No.: US 2012/0286643 A1
(43) Pub. Date: Nov. 15, 2012

(54) Photonic Crystal Incandescent Light Source

(75) Inventor: Geoffrey A. Ozin, Toronto (CA)

(73) Assignee: OPALUX INCORPORATED, Toronto, ON (CA)

(21) Appl. No.: 13/509,544

(22) PCT Filed: Nov. 12, 2010
(86) PCT No.: PCT/CA10/01811

§ 371 Date: Aug. 1, 2012

Related U.S. Application Data
(60) Provisional application No. 61/260,525, filed on Nov. 12, 2009.

(51) Int. Cl. H01K 1/26; H01K 3/02

(52) U.S. Cl. 313/112; 445/27

(57) ABSTRACT

A photonic crystal incandescent light source comprising: a photonic crystal having a structure configured to reflect wavelengths from at least a portion of an infrared spectrum; and an incandescent central filament in the photonic crystal, causing the photonic crystal to transmit wavelengths from at least a portion of a visible spectrum; wherein the light source emits at least a portion of visible wavelengths and suppresses emission of at least a portion of infrared wavelengths.

### TECHNICAL FIELD

The present disclosure relates to a photonic crystal incandescent light source, and more particularly to a photonic crystal incandescent light source comprising one or more photonic crystal layers.

### BACKGROUND

Amongst contemporary lighting technologies, the incandescent light source is unique in that the source of visible light stems from black body radiation emitted from a resistively heated tungsten filament. This is to be contrasted with alternative lighting devices, exemplified by fluorescent, discharge and light emitting diode light sources, which generate light by the radiative recombination of electrons and holes that have been electrically or optically excited in a luminescent gas or solid. However, unlike the broad spectral distribution of light emitted from an incandescent light source that encompasses much wasted infrared and little productive visible wavelengths, the spectrum of light from fluorescent, discharge and light emitting diode light sources is discrete and can be arranged to be in the useful visible wavelength range.

In a world that is exceptionally conscious of energy conservation, the major criticism of the incandescent light source is that roughly 90% of the input power is wasted as heat rather than utilized as productive visible light. As the U.S. alone uses about 20% of its electrical supply for lighting it is clear that a huge energy and cost savings could be realized by just small improvements in the energy efficiency of incandescent light bulbs. Yet the incandescent light source remains desirable because of its warm pleasant color emanating from a broad emission spectrum that is compatible with the human visual system, plus a quick start, voltage controlled light intensity, safety of use and disposal, and low cost. Despite its many attractive features the consensus is that unless the energy efficiency of the incandescent light source can be significantly improved, it will likely be displaced by a more efficient compact fluorescent light source, even though they currently fall short on user-friendly color, adjustable intensity, safety and cost.

One way for making the incandescent light source more energy efficient is based on the integration of a photonic crystal into an incandescent light source, such as an incandescent bulb, to exploit the unique ability of the photonic crystal to selectively pass visible and block infrared wavelengths. A number of approaches have been proposed to achieve this goal. One involves fashioning the incandescent light source as a photonic crystal (Fleming, et al., U.S. Pat. No. 6,768, 256; Freymann et al., 2004, Tungsten Inverse Opals: The Influence of Absorption on the Photonic Band Structure in the Visible Spectral Region, Appl. Phys. Lett. 84, 224-227). Another makes use of a photonic crystal coating on the envelope that encapsulates the incandescent light source (Sommerer et al., U.S. Patent Application Publication No. 2007/0236144). Yet another combines both of these photonic crystal features into the incandescent light source to gain the advantages of both (Sommerer). While these seem like straightforward ways to enhance the energy efficiency of incandescent light bulbs by passing visible and suppressing infrared light, the realization of a practical photonic crystal incandescent light source is thought to depend on the correct combination of materials, compositions and properties, and photonic crystal architectures and photonic lattice dimensions, as together these will determine the efficiency of the light source, stability at the operating temperatures and lifetime of the light source.

Pioneering work on photonic crystal incandescent light bulbs in the patent and scientific literature has focused attention on a tungsten filament with the structure of a Lincoln log pile photonic lattice (Fleming; Lin, et al., 2003, Appl. Phys. Lett. 83:380). It is made by a top-down fabrication process and reflects (i.e., suppresses) infrared wavelengths at the photonic band gap and amplifies and transmits (i.e., emits) visible wavelengths at the high energy photonic band edge. While this work has provided proof-of-principle that an incandescent tungsten photonic crystal filament has the capability to recycle wasted infrared to useful visible light, it is not able to demonstrate an improvement in the energy efficiency of the light source compared to a conventional incandescent light source because the achievable dimensions of the photonic lattice (i.e., log pile size and spacing) are too large to place the photonic band gap and band edge at the optimum wavelengths and thereby prove the concept viable. Plus the thermal instability of nanoscale tungsten wires comprising the photonic crystal device with respect to deleterious tungsten metal atom diffusion and resulting mechanical failure of the photonic lattice at operating temperature is thought likely to lead to catastrophic collapse of the photonic crystal filament.

To achieve smaller photonic lattice dimensions, improved thermal stability and more efficient cycling of infrared to visible light, an alternative bottom-up self-assembly process has been described in that makes use of silica opal to template an inverse opal tungsten photonic crystal filament (Freymann). Along similar lines, patents describe protocols for making opal and inverse opal materials and architectures from refractory metals and metal carbides, nitrides and oxides, for possible use as an incandescent light source and/or coating on the envelope of a light bulb (Sommerer). The objective of this work appears to be to selectively reflect/suppress and transmit/emit infrared and visible wavelengths, respectively. The patentee states (Sommerer), its purpose is “to illustrate specific material screening methodologies used to identify candidate materials in accordance with the chemical stability specifications delineated in the examples given”. However, none of the examples described in these patents appear to have been reduced to practice. There is no experimental or theoretical evidence described therein that provides credence that any of the materials or photonic crystal architectures claimed would actually work in practice and achieve the goal of providing an enhanced energy efficiency incandescent light bulb.

While it may be known that interference filter coatings can be deposited on the glass housing to reflect infrared emitted wavelengths back to the incandescent light source and thereby reduce the power requirements and increase the energy efficiency of the light bulb, the problem exists that manufacture of these coatings is a time consuming, complex and costly process. Therefore a need exists to find an alternative solution to the creation of light bulb interference coatings on the glass housing which overcomes these manufacturing challenges and economic disadvantages.

### SUMMARY

In some aspects, this disclosure describes a bottom-up self-assembly pathway to photonic crystal structures that may function as a photonic crystal incandescent light source. Such a light source may provide better energy efficiency compared to conventional incandescent light sources. Making these structures from a wide variety of materials may be straightforward, may be scalable, and may be relatively inexpensive, as the methods required for their production may be compatible with existing light source facilities.

In some aspects, a process for making a photonic crystal coating on an envelope of the photonic crystal incandescent light source is also described. This photonic crystal coating may reflect any residual infrared light emitted from the incandescent filament back onto the hot filament, which may reduce the power required to operate the filament and hence may further help improve the energy conversion efficiency of the incandescent light source. These photonic crystal coated glass housings may be manufactured in a straightforward, relatively rapid and relatively low cost process. The coating may also be designed to provide the light source with air sterilization, purification, and/or odour removal capabilities.

In some aspects, there is provided a photonic crystal incandescent light source comprising: a photonic crystal having a structure configured to reflect wavelengths from at least a portion of an infrared spectrum; and an incandescent central filament in the photonic crystal, causing the photonic crystal to transmit wavelengths from at least a portion of a visible spectrum; wherein the light source emits at least a portion of visible wavelengths and suppresses emission of at least a portion of infrared wavelengths.

In some aspects, there is provided a photonic crystal incandescent light source comprising: a central incandescent filament; and a photonic crystal arranged to substantially surround the filament, the photonic crystal having a longitudinal axis coaxial with a longitudinal axis of the filament; wherein the photonic crystal has a structure configured to reflect at least a portion of wavelengths from an infrared spectrum and to transmit wavelengths from at least a portion of a visible spectrum.

In some aspects, there is provided method for manufacturing the light sources described above.

### BRIEF DESCRIPTION OF THE DRAWINGS

FIG. 1 is a front view of an example photonic crystal incandescent light source having an envelope;

FIG. 2 is a diagram showing the reflection spectra of an example photonic crystal incandescent light source;

FIG. 3 is a diagram of an example photonic crystal incandescent light source;

FIG. 4 is a diagram of another example photonic crystal incandescent light source;

FIG. 5 is a diagram of another example photonic crystal incandescent light source;

FIG. 6 is a flowchart illustrating an example method of manufacturing the photonic crystal light source, including the envelope;

FIG. 7A is a diagram of another example photonic crystal incandescent light source;

FIG. 7B is a diagram of another example photonic crystal incandescent light source;

FIG. 8 is a diagram of another example photonic crystal incandescent light source; and

FIG. 9 is a diagram illustrating the spectral behaviour of an example photonic crystal incandescent light source.

### DETAILED DESCRIPTION

### Sandwich Embodiment

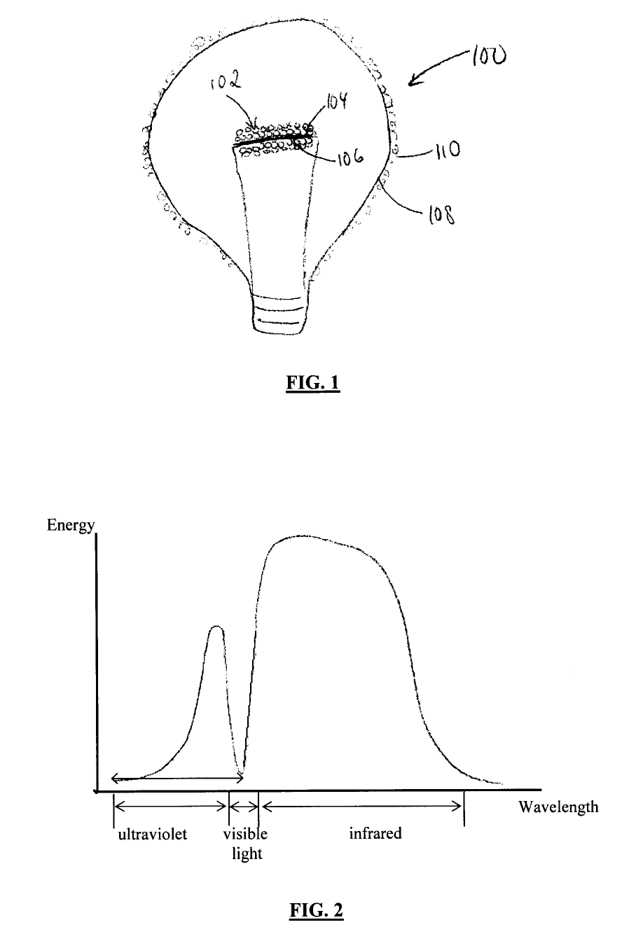

Reference is now made to FIG. 1, which shows an embodiment of a photonic crystal incandescent light source 100, in this case including a transparent or translucent envelope in the form of a bulb. The photonic crystal light source 100 in this example includes a photonic crystal 104 with a central incandescent filament 106, acting as a photonic crystal defect, which may be electrically heated to provide incandescent light. The filament 106 and photonic crystal 104 may be mounted inside a transparent or translucent housing or envelope 108, similar to conventional incandescent light sources.

In the example shown, the light source 100 includes the central filament 106 embedded within the photonic crystal 104, which central filament 106 may be heated to provide incandescent light. This particular architecture may enable it to function as an incandescent light source whereby it is able to reflect or suppress light at wavelengths (e.g., wavelengths from at least a portion of the infrared spectrum) corresponding to the photonic band gap of the photonic crystal 104 while emitting or transmitting light at the wavelengths (e.g., wavelengths from at least a portion of the visible spectrum) corresponding to the defect state created by the central filament 106 in the photonic crystal 104.

The photonic crystal incandescent light source 100 may include a photonic crystal coating 110 on the envelope 108. The photonic crystal coating 110 may be designed to reflect at least a portion of wavelengths in the infrared spectrum, with the result that residual infrared emissions not reflected by the photonic crystal 104 may be reflected by the coating 110 on the envelope 108, back onto the filament 106, and thus may reduce the power required to hold the filament 106 at its operating temperature and may help the energy conversion efficiency of the light source 100.

The photonic crystal 104 may be designed to have a band gap or stop gap that reflects or suppresses certain wavelengths of light. The central filament 106 when heated may perform a dual function: it may act as an incandescent light source by providing a broad spectral distribution of black body radiation while at the same time it may behave as a defect in the photonic crystal 104, resulting in the transmission or emission of wavelengths falling within the defect state while the other wavelengths in the band gap or stop gap would still be reflected by the photonic crystal 104.

The central filament 106 may give rise to a defect resonant state within the photonic band gap, in which wavelengths within the resonant state are transmitted or emitted through the band gap, while other wavelengths in the band gap may be still reflected. In particular, the photonic band gap may be designed to reflect visible and infrared wavelengths while the central filament 106 may be designed to create a defect state in the visible wavelengths. Thus, at least a portion of visible wavelengths (e.g., 400-700 nm) may be transmitted while at least a portion of infrared wavelengths (e.g., >700 nm) may be reflected or suppressed. In other words, visible photons at the wavelength of the defect resonant state may be permitted to tunnel through the photonic crystal 104 whereas infrared photons may be trapped within. Thus, the trapped infrared photons, rather than be wasted as heat, may help to maintain the temperature of the filament 106 and thus aid in reducing power consumption by the light source 100.

FIG. 2 illustrates an example of a reflection spectrum produced by the band gap or stop gap of the photonic crystal 104 which covers both visible and infrared wavelengths. However, in this example, the central filament 106, acting as a defect in the photonic crystal 104, gives rise to a defect state in the visible wavelengths, thus permitting visible light to be transmitted through the photonic crystal 104. The infrared wavelengths are still reflected and thus suppressed by the photonic crystal 104. By decreasing the emission of infrared wavelengths while permitting transmission of visible wavelengths, the overall energy efficiency of the filament 106 may be improved. In some examples, the band gap or stop gap may also permit transmission of ultraviolet light. This may be useful where ultraviolet light is used for photocatalytic processes, for example where the light source 100 has a photocatalytic coating for air sterilization, air purification and/or odour removal.

Production of this photonic crystal incandescent filament and light source may use a wide variety of materials suitable for making the filament and photonic crystals in a relatively inexpensive process, which may be scalable as the manufacturing methods may be compatible with existing light source manufacturing facilities.

As will be described below, possible variations to the light source may include one or more of:

1. wherein the filament is electrically heated.
2. where the central filament is a wire, rod, ribbon or sheet.
3. wherein the central filament is electrically conductive.
4. wherein the central filament is made from a metal, semimetal or semiconductor having a high melting point.
5. wherein the central filament is made from a material selected from the group consisting of: carbon, silicon silicon carbide, tungsten, niobium, tantalum, rhodium, iridium, rhenium, osmium, ruthenium, palladium, platinum, zirconium, hafnium, and carbides, nitrides, silicides, borides and oxides thereof.
6. wherein the photonic crystal comprises a periodic dielectric lattice, the dielectric lattice comprising materials having variations in at least one of composition, volume filling fraction and porosity, which give rise to dielectric differences.
7. wherein the photonic crystal has a dimensionality of its photonic lattice of one, two or three dimensions.
8. wherein the photonic crystal comprises a three-dimensional opal or inverse opal structure.
9. wherein the opal or inverse opal structure comprise a semiconductor or an insulator material.
10. wherein the opal or inverse opal structure comprise a material that provides the photonic crystal with a high dielectric contrast and a large photonic band gap or stop gap.
11. wherein the opal or inverse opal structure comprise a high melting point material.
12. wherein the opal or inverse opal structure comprise a material that has a high dielectric constant and is a high melting point insulator.
13. wherein the opal or inverse opal structure comprise a metal oxide or a complex metal oxide.
14. wherein the photonic crystal comprises a one-dimensional multilayer Bragg minor.
15. wherein differences in the dielectric constants of the layers of the Bragg minor stem from differences in composition, porosity and thickness.
16. wherein the layers of the Bragg mirror comprise a semiconductor or insulator material.
17. wherein the layers of the Bragg mirror comprise a material that provides the Bragg minor with a high dielectric contrast and a large photonic band gap or stop gap.
18. wherein the layers of the Bragg minor comprise a material having a high melting point.
19. wherein the layers of the Bragg minor comprise a material that has a high dielectric constant and is a high melting point insulator.
20. wherein material having a high dielectric constant and being a high melting point insulator is a metal oxide or a complex metal oxide.

Where the light source includes a transparent or translucent envelop housing the photonic crystal and filament, variations may include one or more of:

1. wherein the envelope has a photonic crystal coating that selectively transmits visible wavelengths and selectively reflects infrared wavelengths.
2. wherein the filament and the photonic crystal is shaped to match an external surface of the envelope, for maintaining a substantially constant angle of light transmission from the filament to the envelope.
3. wherein the photonic crystal coating on the envelope comprises a periodic dielectric lattice, the dielectric lattice comprising materials having variations in at least one of composition, volume filling fraction and porosity, which give rise to dielectric differences.
4. wherein the photonic crystal coating on the envelope displays a photonic band gap or stop gap which reflects at least a portion of infrared spectral wavelengths.
5. wherein the photonic crystal coating on the envelope has a dimensionality of one, two or three dimensions.
6. wherein the photonic crystal coating on the envelope has a dimensionality of one dimension, and the photonic crystal coating has a Bragg stack structure.
7. wherein the photonic crystal coating on the envelope has a dimensionality of three dimensions and the photonic crystal coating has a three-dimensional opal or inverse opal structure.
8. wherein the opal or inverse opal structure comprise materials with differences in at least one of composition, porosity and volume filling fracture, which give rise to differences in the dielectric constant of the materials.
9. wherein the opal or inverse opal structure comprise a semiconductor or insulator material.
10. wherein the opal or inverse opal structure comprise a material that provides the opal or inverse opal structure with a high dielectric contrast and a large photonic band gap or stop gap.
11. wherein the opal or inverse opal structure comprise a high melting point material.
12. wherein the opal or inverse opal structure comprise a material that has a high dielectric constant and is a high melting point insulator.
13. wherein the material having a high dielectric constant and being a high melting point insulator material is a metal oxide or a complex metal oxide.
14. wherein the material having a high dielectric constant and being high melting point insulator material has a high dielectric constant and is a high melting point semiconductor or insulator material.
15. wherein the material having a high dielectric constant and being a high melting point semiconductor material is titania or silica.
16. wherein the envelope contains an inert gas.
17. wherein the inert gas is argon mixed with a gas selected from the group consisting of: methane, nitrogen, silane, diborane, and oxygen.
18. wherein the envelope has a photocatalytic coating that provides the light source with at least one of air sterilization, air purification, and odour removal capabilities.
19. wherein the photocatalytic coating comprises a photonic crystal.
20. wherein the photocatalytic coating comprises metal oxide or complex metal oxide nanoparticles.
21. wherein the metal oxide or complex metal oxide is selected from the group consisting of titanium oxide, vanadium oxide, molybdenum oxide, tungsten oxide, zinc oxide, and strontium titanate.

### EXAMPLES

All examples are provided for the purpose of illustration only, and are not meant to be limiting.

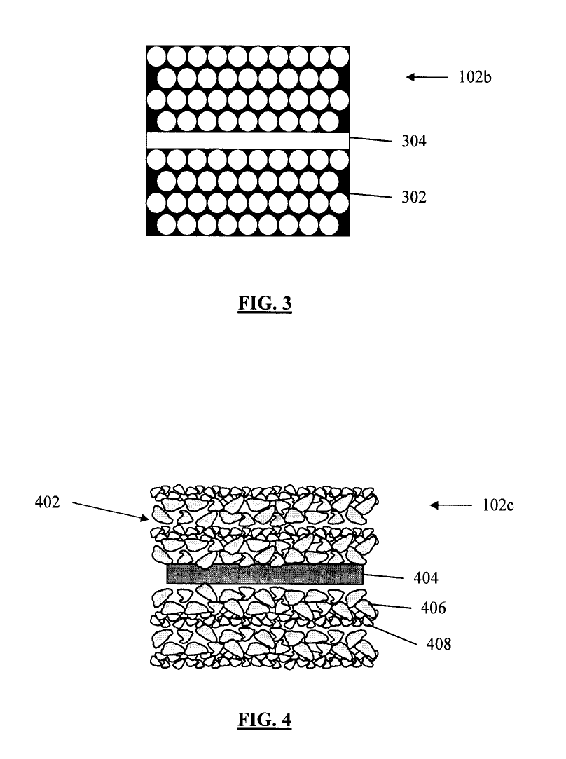

Reference is now made to FIG. 3, which illustrates a section of an example embodiment of the photonic crystal light source 102b. In this example, the light source 102b has a 3D-1D-3D sandwich hetero-structure, in which a 3D photonic crystal 302 with an inverse opal structure contains a planar central filament 304. Although the photonic crystal 302 is shown only on the top and bottom of the planar central filament 304, the photonic crystal 302 may also cover the sides and/or ends of the planar central filament 304 in order to more fully restrict wavelengths emitted from the central filament 304. Efficiency of the photonic crystal light source 102b may be sufficiently improved even if some sides or ends of the planar central filament 304 are not covered by the photonic crystal 302.

In some examples, the photonic crystal light source 102b is an inverse hafnia opal/tungsten/inverse hafnia opal (i-HfO₂-o/W/i-HfO₂-o) structure where the central filament material is chosen to function as the incandescent filament as well as providing the defect mode for transmission of at least a portion of wavelengths in the visible spectrum. Although the central filament 304 is described as comprising tungsten, other materials may also possible, including, for example, carbon, silicon carbide, and iridium. The inverse hafnia opal may be prepared by infiltration of hafnia into a sacrificial opal template by methods including but not limited to atomic layer deposition (ALD), chemical vapour deposition (CVD), aerosol assisted chemical vapour deposition (AACVD), plasma enhanced chemical vapour deposition (PECVD), sol-gel chemistry and so forth. Although not limited to this composition, the choice of hafnia may be useful because: it is a refractory mechanically robust dielectric with a high melting point and negligible vapour pressure at operating temperatures (e.g., 2000K). Volatilization of the filament could be reduced and its operating lifetime increased by the addition of argon-oxygen gas inside the envelope containing the filament. In addition, hafnia is optically transparent in the visible and infrared wavelength range and has a high refractive index. It may therefore be arranged to generate a relatively wide photonic band gap, for example one that straddles the infrared-visible spectral range, which may improve its ability to reflect or suppress the emission of infrared radiation (e.g., wavelengths >700 nm).

Reference is now made to FIG. 4, which shows a section of another example embodiment of the photonic crystal light source 102c. In this example, the photonic crystal light source 102 has a 1D-1D-1D sandwich hetero-structure in which the light source 102c includes a one-dimensional photonic crystal 402 with an incandescent central filament 404 that provides a defect state for transmitting visible light. A one-dimensional photonic crystal may be referred to as a Bragg stack or a Bragg mirror, and functions as the photonic crystal back-reflector or suppressor for infrared radiation. The 1D photonic crystal 402 may comprise alternating nanoparticle multilayers 406 and 408 having different refractive indices. For example, some multilayers 406 may have greater porosity than other multilayers 408. Other possibilities include alternating multilayers comprising different materials with different refractive indices. An example of materials for this embodiment may be: multilayer nanoparticle hafnia/tungsten/multilayer nanoparticle hafnia, where the multilayers may have different layer porosity P1 and P2 ([HfO₂ (P1)][HfO₂ (P2)]n/W/[HfO₂ (P1)][HfO₂ (P2)]n). The different porosity layers in the high refractive index hafnia may provide the Bragg mirror with sufficient refractive index contrast to give it a relatively wide photonic band gap or stop gap. A relatively wide band gap or stop gap may be useful for suppressing or reflecting a wider range of infrared wavelengths. Although hafnia and tungsten are provided as examples here, other materials may be suitable for the photonic crystal 402 and the central filament 404. For example, the photonic crystal 402 may include low refractive index thermally stable nanocrystalline magnesium difluoride and high refrective index thermally stable nanocrystalline diamond alternating layers, and the central filament 404 may be carbon, silicon carbide, or iridium. Similar to the 3D-1D-3D photonic crystal light source 102b described above, this 1D-1D-1D photonic crystal light source 102c transmits at least a portion of visible light through the band-pass defect mode created by the incandescent central filament 404 and reflects or suppresses at least a portion of infrared light from an intense and broad photonic band gap or stop gap. Again the incandescent central filament 404 acts as both the incandescent source and the defect in the photonic crystal 402.

### Materials and Design

The design of the photonic crystal the materials used for the crystal may be varied. The synthesis, structure and property relations of the photonic crystal may be chosen to select certain optical and/or photonic properties, the energy efficiency, thermal, mechanical and/or chemical stability, and/or the working lifetime of the photonic crystal incandescent light source.

The photonic crystal may have a lattice dimensionality of 1D, 2D or 3D. Various designs comprised of a diversity of materials compositions and structures may be suitable and understood by persons skilled in the art. The refractive index contrast (RIC) of the photonic crystal and the thickness of the photonic crystal (e.g., the number of unit cells) may be selectable to achieve a certain photonic band gap over a certain wavelength range. Typically, the greater the thickness and RIC of the photonic crystal, the narrower and more effective is the band gap. For the photonic crystal incandescent light source, the photonic crystal may be designed to give rise to a photonic band gap that is wide enough to cover a substantially large portion of the infrared spectrum that would be emitted by an incandescent source to reflect or suppress the infrared wavelengths while transmitting substantially all or at least a portion of wavelengths from the visible spectrum.

In some examples, materials for the photonic crystal may be chosen to withstand the conditions experienced by an incandescent filament, which may operate at temperatures above 2000K. The photonic crystal can be designed to have relatively good optical and/or photonic properties, and/or thermal, mechanical and/or chemical stability at this temperature. Suitable materials may include, for example, high melting point carbon (C), silicon (Si) and silicon carbide (SiC) as well as high melting point metals like tungsten (W), niobium (Nb), tantalum (Ta), rhodium (Rh), iridium (Ir), rhenium (Re), osmium (Os), ruthenium (Ru), palladium (Pd), platinum (Pt), zirconium (Zr) and hafnium (Hf) and their carbides, nitrides, silicides, borides and oxides. The materials chosen may have high RIC between components of the photonic lattice to ensure reflection efficiency at the wavelength of the photonic band gap and provide a photonic band gap with a relatively wide band width.

The incandescent central filament can also be designed to provide a defect state or states at certain wavelengths. The thickness of the incandescent central filament can be varied from below to above the lattice dimension of the photonic crystal in order to control the number, wavelength, band width and/or transmittance of defect states in the photonic band gap. Typically, a central filament that has a thickness less than the lattice dimension of the photonic crystal gives rise to a single defect state, while a central filament that has a thickness greater than the lattice dimension gives rise to multiple defect states. The width of the defect state or states may be varied by using materials with different refractive indices as the incandescent central filament. The position of the defect state may also be varied by controlling the thickness of the incandescent central filament, for example a thicker central filament may give rise to a defect state in a higher wavelength range. The width and position of the defect state or states may be designed to result in emission of coloured light. For example, the incandescent central filament may be designed to have a thickness and refractive index such that it gives rise to a defect state limited to wavelengths of around 600 nm, so that the light emitted from the light source is perceived as being orange in colour.

The incandescent central filament may be, for example, a planar filament, a rod filament, a wire filament, or may have any other suitable geometry, including irregular geometry. The materials for the filament may be chosen based on its thermal, mechanical and/or chemical stability at operating temperatures (e.g., above 2000K). Representative suitable materials for this task may include, for example, high melting point carbon (C), silicon (Si) and silicon carbide (SiC) as well as high melting point metals like tungsten (W), niobium (Nb), tantalum (Ta), rhodium (Rh), iridium (Ir), rhenium (Re), osmium (Os), ruthenium (Ru), palladium (Pd), platinum (Pt), zirconium (Zr) and hafnium (Hf) and their carbides, nitrides, silicides, borides and oxides.

In some examples, the photonic crystal incandescent light source may exhibit angle-dependence of the emitted light. Typically, the reflectance spectrum of a photonic crystal is angle-dependent, meaning that the light reflected at one viewing angle can be different from the light reflected at another viewing angle. Thus, a photonic crystal incandescent light source having a non-cylindrical central filament or non-uniform photonic crystal about the circumferencial surface of the filament may exhibit angle-dependence of the emitted light. The angle-dependence can be designed to control both the wavelength range over which it reflects or suppresses the infrared wavelengths and over which it transmits visible wavelengths. This can be useful for an incandescent source that is designed to emit light in all directions. The angle-dependence stop gap or band gap and the defect state may be tuned to trap more infrared and pass more visible light over a relatively large cone angle, which may be useful for an incandescent source that emits light in all directions.

Reference is now made to FIG. 5, which shows an example photonic crystal incandescent light source 102 that has a curvature. Such a light source 102 may be manufactured, for example, by providing a curved incandescent central filament 106 and forming the photonic crystal 104 around the incandescent central filament 106. Angle-dependence of emitted light could be a concern in a light source, where it may be useful to provide substantially uniform light at substantially all viewing angles. An example method to address this is to use a filament 106 and photonic crystal 104 that conforms or substantially conforms to the external surface or shape of an envelope housing the filament 106, such that the light reflected from the photonic crystal 104 is at substantially the same angle regardless of the angle at which the light source 102 is viewed.

### Substantially Concentric Embodiment

In some embodiments, rather than being a sandwich heterostructure, as described above, the light source includes a central incandescent filament substantially surrounded by a photonic crystal. In this embodiment, the photonic crystal substantially surrounds the central filament, and has a longitudinal axis coaxial with the longitudinal axis of the central filament. In some examples, the photonic crystal surrounds the central filament in a substantially cylindrical coaxial configuration. By describing the photonic crystal layer as having a substantially cylindrical coaxial configuration, it is meant that the photonic crystal is arranged as a concentric substantially cylindrical structure about the longitudinal axis of the central filament.

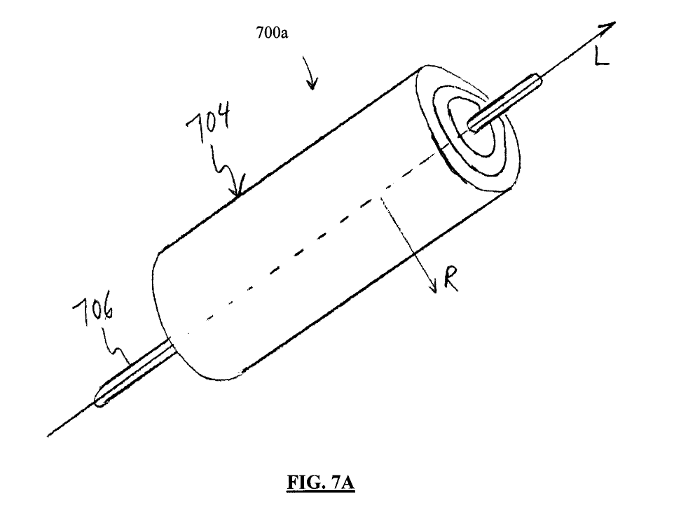

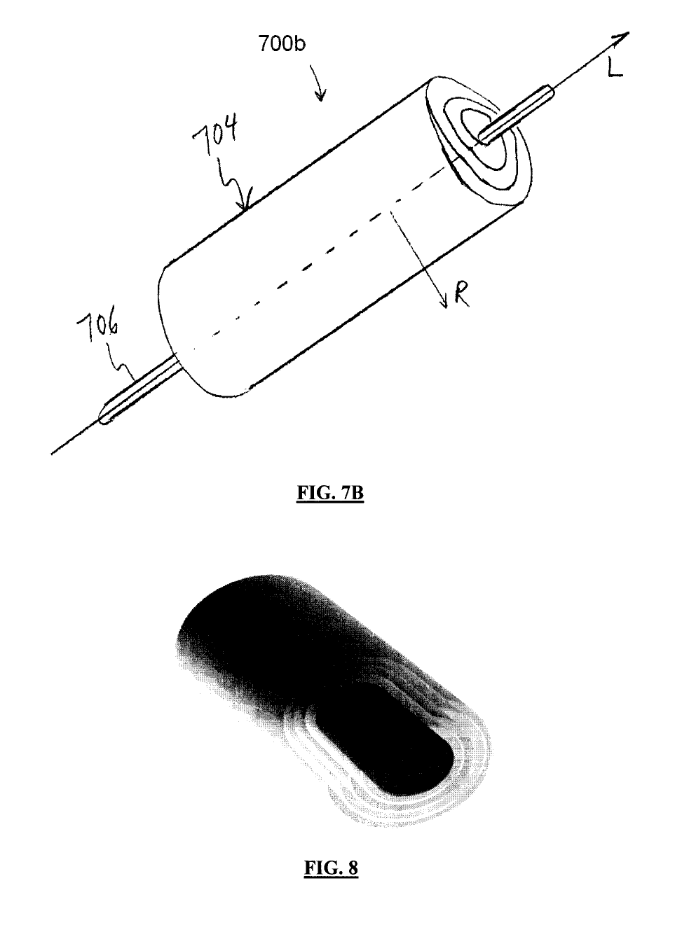

Example embodiments are illustrated in FIGS. 7A and 7B. FIG. 7A illustrates an example embodiment of the photonic crystal incandescent light source 700a where the photonic crystal 704a has a cylindrical structure substantially surrounding the filament 706, and where the photonic crystal 704a includes concentric layers. FIG. 7B illustrates an example embodiment of the photonic crystal incandescent light source 700b where the photonic crystal 704b has a spiral structure that is substantially cylindrical and surrounding the filament 706. Where the photonic crystal 704b may include layers, the layers may also have a similar spiral structure. In both light sources 700a and 700b, the longitudinal axis of the photonic crystals 704a and 704b are coaxial with the longitudinal axis L of the filament 706. Where the photonic crystal 704a, 704b include layers, the layers are arranged outwards, in the radial direction R from the longitudinal axis L of the filament 706. For example, where the photonic crystal 704a, 704b include alternating layers (e.g., where the photonic crystal 704a, 704b is a Bragg stack), the layers alternate in the radial direction R.

Where the photonic crystal comprises layers (e.g., where the photonic crystal is a Bragg stack), the layers may be substantially concentric layers sharing the same longitudinal axis, for example each layer may be a concentric cylindrical layer. In some embodiments, the photonic crystal is not strictly cylindrical structure with concentric layers, for example it may be a spiral structure wound about the central filament. In some examples, such a spiral structure may be formed by winding or rolling a photonic crystal film about the central filament. Where the photonic crystal film is relatively thin (e.g., on the order of 1-10 gm), such a spiral structure may effectively function similar to a strictly cylindrical structure with concentric layers. Although the layers in a photonic crystal having a spiral structure may also have a spiral structure, it should be understood that such layers may be considered substantially concentric layers.

FIG. 8 illustrates an example embodiment of the filament having concentric photonic crystal layers, with the filament partially cut away to reveal the layers. In the example shown, the photonic crystal includes multiple layers, having alternating materials and/or alternating porosity, to form a concentric coaxial Bragg stack. The materials used and the structure of the photonic crystal layers may be selected to achieve a desired level of efficiency, stability and/or lifetime at a certain operating temperature, for example.

The central filament may be any suitable conventional incandescent filament. When electrically heated, the filament acts as an incandescent light source by emitting a broad spectral distribution of black body radiation while the photonic stopband of the photonic crystal reflects wavelengths (e.g., at least a portion of infrared wavelengths longer than about 700 nm) back onto the filament, while transmitting visible wavelengths (e.g., at least a portion of wavelengths in the range of about 400 nm to about 700 nm). The light source may effectively recycle at least a portion, or a majority, of infrared light back into heating of the central incandescent filament rather than being wasted as heat, thereby helping to increase the overall energy efficiency of the photonic crystal incandescent light source. In some examples, the photonic crystal may surround substantially the entire length of the central incandescent filament, although in some embodiments the entire length of the central filament is not covered by the photonic crystal. In some examples, the photonic crystal may surround one or more portions of the length of the filament.

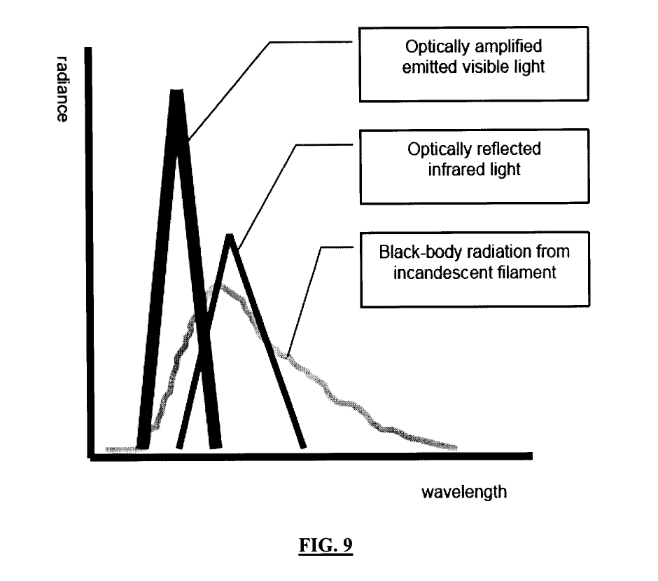

FIG. 9 is a spectral diagram illustrating the operation of an example photonic crystal incandescent light source. The diagram shows an example spectral profile of black-body radiation emitted by the central incandescent filament. Over this is superimposed the spectral profile of the stopgap of an example photonic crystal, illustrating the wavelengths (in this example, in the infrared range) that are reflected back onto the central filament. Also shown is an example spectral profile of emitted visible light at the band edge of the photonic stopband, where there may be present a slow photon effect, which optically amplifies the visible light transmitted by the photonic crystal.

Although the central filament has been shown in examples as having a rod or cylindrical shape, the filament may be a planar filament, a wire filament, a or any other suitable geometry, including irregular geometry. The filament may be further shaped, for example coiled or otherwise bent. Although the photonic crystal has been described in examples as being substantially cylindrical, the photonic crystal may substantially surround the filament in any suitable geometry, including a suitable geometry matching that of the filament, including irregular geometry. In some examples, a substantially cylindrical photonic crystal may be useful to avoid or reduce angle dependency of emitted wavelengths from the light source.

The photonic crystal incandescent light source may be made from any material suitable for making incandescent filaments and photonic crystal. For example, the central filament may be made of a tungsten material. The photonic crystal may be in the form of a Bragg stack, for example having magnesium oxide (MgO) and hafnia oxide (HfO₂) layers or magnesium difluoride (MgF₂) and diamond (C) layers alternating radially from the longitudinal axis of the filament. Alternatively, the photonic crystal may be in the form of an inverse opal, for example having HfO₂ particles arranged in a lattice structure, either with uniform porosity or with different porosity. For example, the photonic crystal may have a porosity gradient, which in some examples may be formed by dip coating nanocrystal layers with gradually changing thicknesses.

Because the photonic crystal substantially surrounds the filament and is coaxial with the longitudinal axis of the filament, this embodiment of the photonic crystal filament may not exhibit angle-dependence, or may exhibit reduced angle-dependence. That is, the emitted visible light may be substantially the same from all viewing angles.

### Materials and Design

The central incandescent filament may be made of any suitable conventional material used for conventional incandescent filaments.

The material for the photonic crystal may be selected based on the thermal, mechanical and/or chemical stability of the material at operating temperatures, which may be about 2000 K. Materials suitable for this task may include, for example, carbon materials (e.g., diamond), silicon materials (e.g., silicon carbide), and refractory metal carbides, nitrides, silicides, borides, fluorides, and oxides. The photonic crystal material may also be selected to have a sufficiently high refractive index contrast between components of the photonic lattice, to help ensure good reflection efficiency at the wavelength of the photonic bandgap, to provide a photonic band gap with a sufficiently large bandwidth, and to help ensure a low photon group velocity.

In examples where the photonic crystal is a one dimensional photonic crystal, such as a photonic crystal having a Bragg stack structure, the alternating layers of the Bragg stack struck may be formed by nanocrystals. The nanocrystals may be selected to have a high difference in refractive indices. For example, the photonic crystal may comprise the two materials MgF₂, which has a low refractive index, and diamond, which has a high refractive index. In general, the use of materials with a large difference in refractive indices, in the alternating layers that make up the photonic crystal, may be useful in helping to obtain a more useful optical response.

The number of unit cells in the photonic crystal may also be selected to control the width of the resultant photonic bandgap and/or the group velocity of light, which may influence the efficiency of reflected infrared light and/or optical amplification of transmitted visible light.

The bandwidth of the photonic bandgap may be widened by providing a photonic crystal including photonic crystal layers having different lattice dimensions and/or refractive index contrasts, where the overall resultant bandgap would be a convolution of the photonic bandgaps of each of the constituent photonic crystal layers. Alternatively or in addition, the photonic crystal may exhibit a gradation in porosity, rather than discreet layers with different porosity. A gradation in porosity may give rise to a similar widened bandgap.

In an example, the photonic crystal is in the form of a Bragg stack, with hafnia-based layers. For example, hafnia nanocrystals may be made using a non-hydrolytic sol-gel hot injection synthesis, with Hf(OⁱPr)₄ and HfCl₄ precursors, TOPO as solvent and capping ligand at 340° C. that yields monodispersed HfO₂ nanocrystals with sizes in the range of about 3 nm to about 5 nm. Thermal or oxygen plasma treatment may be used to remove the capping-ligands from the formed nanocrystals. Atomic layer deposition using HfCl₄ may provide a suitable way of synthesising, in a layer-by-layer fashion, inverse hafnia opals i-HfO₂-o using opal templates. Each layer of the Bragg stack may have a thickness of about 200 nm, and the Bragg stack photonic crystal may comprise, for example, 4 or 5 bilayers (one bilayer being comprised of one layer of each of the alternating layers). The photonic crystal may be designed to have a porosity of about 40%.

Using nanocrystals rather than larger microspheres to form the photonic crystal (e.g., as layers in a Bragg stack) may be useful where the central filament is relatively thin (e.g., about 1 to 2 μm in diameter), which may make it difficult to form regular lattice structures about the central filament using microspheres (which typically have diameters on the order of 1 μm). Nanocrystals may have diameters as small as 1 to 5 nm, which permit the nanocrystals to form regular lattice structures about the perimeter of a cylindrical filament having a relatively thin diameter.

Hafnia-based materials may be suitable for forming the photonic crystal since it has been found to be a relatively refractory mechanically robust dielectric with a relatively high melting point of about 2758° C. and relatively negligible vapour pressure at operating temperatures of an incandescent filament. Additionally, hafnia is substantially optically transparent in the visible and infrared wavelength range and has a relatively high refractive index. Thus, it may be arranged to generate a relatively wide photonic bandgap that straddles the black-body infrared spectral range, thereby helping to maximize the ability of the photonic crystal layer(s) to reflect infrared emission (e.g., wavelengths longer than about 700 nm) and simultaneously amplify and transmit by the slow photon effect visible emission (e.g., wavelengths in the range of about 400 nm to about 700 nm). Other suitable refractory nanocrystalline materials may be used, including, for example diamond, MgF₂, MgO, Al₂O₃, ZrO₂ and CeO₂ (Pinna, et al., 2008, Chem. Int. Ed., 47:2).

### Envelope

As described above, the photonic crystal incandescent light source may include a transparent or translucent envelope (e.g., a glass envelope) housing the photonic crystal and central incandescent filament.

The efficiency of the photonic crystal incandescent light source may be enhanced by coating the envelope with a photonic crystal coating. Such a coating could reflect any residual infrared wavelengths emitted from the photonic crystal back from the envelope surface to the filament where it is absorbed, which may help reduce the power required to maintain the filament at its operating temperature.

A photonic crystal coating may be grown on the envelope, for example using a dip-coating evaporation induced self-assembly process, resulting in a photonic crystal film (e.g., silica opal photonic crystal film) on the envelope surface. An example method of achieving this is by slowly withdrawing the envelope from a dispersion of microspheres (e.g., an ethanolic dispersion of silica microspheres) whereupon the microspheres will spontaneously organize on the envelope into the form of an opal photonic crystal coating. The dip-coating process may be tailored to create transparent or translucent coatings with respect to at least a portion of visible light but reflective to at least a portion of infrared wavelengths. In some examples, opal photonic crystal coatings may be formed on the envelope of the light source using an aerosol assisted deposition process whereby aerosol droplets comprised of a dispersion of microspheres (e.g., an ethanol dispersion of silica microspheres) deposited on the envelope will cause the microspheres to spontaneously organize on the envelope in the form of an opal photonic crystal coating. The dip-coating and/or aerosol processes may be tailored to create transparent or translucent coatings with respect to at least a portion of visible light but reflective to at least a portion of infrared wavelengths. The result is that the photonic crystal coated envelope may transmit at least a portion of visible wavelengths and reflect at least a portion of infrared wavelengths from the broad spectral distribution of black body radiation emitted from an incandescent source contained within and that impinges upon said photonic crystal coated envelope.

In some examples, the mechanical stability of the photonic crystal coating on the envelope could be enhanced by necking the microspheres. An example method is to expose the photonic crystal coating to the vapour of tetramethoxysilane whereupon the microspheres are connected together by silica at their necking points. The thickness and strength of the necks may depend on the time of exposure of the photonic crystal coating to the tetramethoxysilane vapour. In some examples, a thermal post-treatment may further consolidate the silica necks thereby further increasing the mechanical stability of the photonic crystal coating.

The size of the coating microspheres, the extent of the necking and/or the thickness of the photonic crystal coating may be tailored to control the wavelength, intensity and/or band width of the photonic band gap of the coating on the envelope, similar to the photonic crystal, as discussed above. The photonic crystal coating may be configured to transmit at least a portion of visible light but reflect at least a portion of residual infrared light emitted from the incandescent filament back onto the hot filament, which may help reduce the power requirement to operate the filament and hence may help increase the overall energy conversion efficiency of the incandescent light source.

The coating on the envelope could also be designed to provide the photonic crystal incandescent light source with air sterilization, air purification, and/or odour removal capabilities. In some examples, this coating may be a conventional photocatalytic coating for air sterilization. In some examples, this coating may be a photocatalytic coating in the form of a photonic crystal. In some examples, a photonic crystal coating on the outer surface of the envelope could be made to include nanoparticles that can be excited by ultraviolet wavelengths. As ultraviolet wavelengths are emitted by the light source, the nanoparticles are excited to a higher energy state. This results in the presence of positively-charged holes and negatively-charged electrons on the surface of the envelope. Organic compounds in the air that come into contact with the envelope will be reduced or oxidized by these charged particles, thus purifying the air of odours and other undesirables. Suitable materials for these nanoparticles include a range of metal oxides, for example titanium oxide, vanadium oxide, molybdenum oxide, tungsten oxide and zinc oxide as well as complex metal oxides exemplified but not limited to strontium titanate. These nanoparticles can be included in the photonic crystal coating, comprise the photonic crystal coating or even form another layer on top of the photonic crystal coating.

In some examples, the photonic crystal coating on the envelope may be a one-dimensional photonic crystal, for example a photonic crystal having a Bragg stack structure. Such a coating may be formed, for example, by dip coating the envelope in solutions of nanocrystals (such as those described above) to form alternating layers of the Bragg stack. In some examples, thermally stable nanocrystals may be suitable, and the nanocrystals may be chosen such that the alternating layers have a relatively high refractive index contrast.

The photonic crystal coating may include a material designed to make use of any emitted ultraviolet light from the incandescent light source and thereby provide the light source with air sterilization, purification, and/or odour removal capabilities.

The content of the envelope for the incandescent light source can also be selected to help increase the chemical stability of the heated filament and impede its volatilization at the operating temperature (e.g., at 2000K). Thus for the high melting point materials discussed above, the atmosphere in the envelope may be chosen to be an inert gas, for example argon mixed with a small amount of methane, nitrogen, silane, diborane or oxygen, to minimize deleterious vaporization of the hot filament under operating conditions. This may allow volatilization to be reduced and operating lifetime to be increased.

### Method of Manufacture

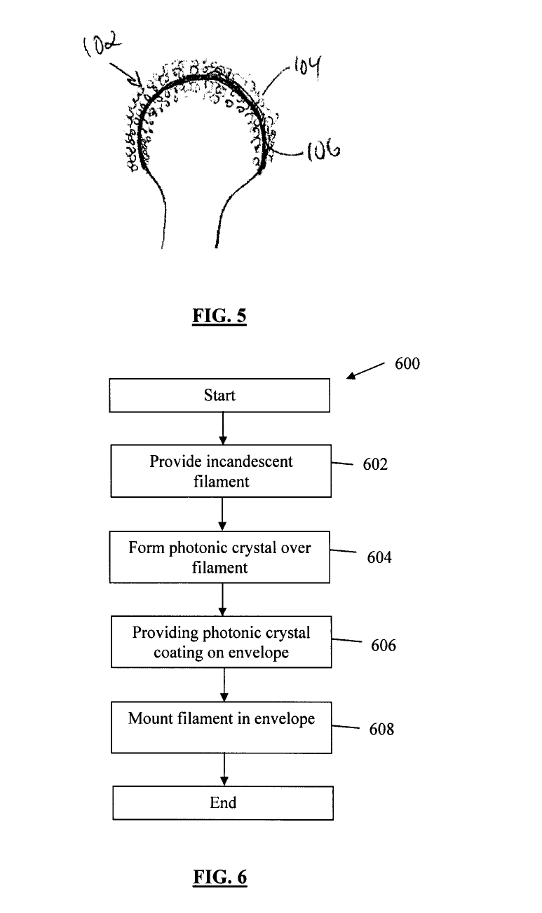

Reference is now made to FIG. 6, which is a flowchart illustrating a method of manufacturing a photonic crystal incandescent light source.

At step 602, an incandescent central filament is made using a suitable material. The filament may be made as a ribbon, a rod, a wire, or any other suitable shape. The filament may be cut or bent to the desired dimensions.

At step 604, a photonic crystal is formed over the central filament. In the case of an opal-based structure, the photonic crystal may be formed by self-assembly of microspheres to form the opal structure. The microspheres comprising the opal structure may be necked to give greater strength and stability to the opal-based photonic crystal.

The opal structure can then serve as a template to replicate the structure as an inverse opal made of any material of practical use as a photonic crystal filament.

In some examples, where the photonic crystal substantially surrounds the central filament and has a longitudinal axis coaxial with the longitudinal axis of the filament, the step 604 may be as follows.

In an example method of manufacture, nanocrystalline Bragg stacks (also referred to as Bragg mirrors) may be deposited on the central filament by repetitive dip-coating from dispersions of nanocrystals, to form alternating concentric layers. The dip-coating process may be controlled in order to obtain layers of certain thicknesses. Different porosity may be introduced into the layers by co-assembly of the nanocrystals with sacrificial intervening nanospheres (e.g., polymer nanospheres, such as polystyrene nanospheres) that are later removed, for example by oxygen plasma or other etching methods. For example, the dispersion of nanocrystals may be mixed with intervening nanospheres at certain concentrations in order to obtain a desired porosity.

In another example method of manufacture, the photonic crystal may be formed as a relatively flat and flexible sheet or film. The photonic crystal may be formed as a Bragg stack sheet or an opal sheet. The sheet may then be wrapped, rolled or otherwise arranged to substantially surround the central filament. The sheet may wrap once around the filament, or may wrap around the filament multiple times to form a coaxial spiral around the filament. Again, the photonic crystal may include intervening nanospheres which are later removed, in order to achieve a desired porosity.

In another example method of manufacture, an inverse opal photonic crystal may be grown directly on the central filament, for example by evaporation induced self-assembly (EISA) of template particles. The template particles form an opal structure surrounding the filament, and is infiltrated (e.g., using chemical vapour or atomic layer deposition, or liquid phase infiltration) by a photonic crystal precursor material (e.g., a polymer or polymer precursor) which is then cured and the template particles are removed. In another example, the EISA method may be used to directly co-assemble the photonic crystal precursor material with the template nanocrystals, followed by removal of the template material as described above.

At step 606, optionally, an envelope is provided. The envelope is optionally dipped in a dispersion of microspheres, and slowly withdrawn from the dispersion and dried, resulting in a self-assembled 3D photonic crystal coating on the envelope.

At step 608, the photonic crystal filament is optionally mounted inside the envelope using techniques similar to those for conventional incandescent light sources.

While the above description has been provided for certain embodiments, materials and techniques, it will be understood that other variations and substitutions may also be possible. Any examples provided are for the purpose of illustration only and are not intended to be limiting. All references provided are hereby incorporated by reference in their entirety.

1. A photonic crystal incandescent light source comprising:
a photonic crystal having a structure configured to reflect wavelengths from at least a portion of an infrared spectrum; and
an incandescent central filament in the photonic crystal, causing the photonic crystal to transmit wavelengths from at least a portion of a visible spectrum;
wherein the light source emits at least a portion of visible wavelengths and suppresses emission of at least a portion of infrared wavelengths.

2. A photonic crystal incandescent light source comprising:
a central incandescent filament; and
a photonic crystal arranged to substantially surround the filament, the photonic crystal having a longitudinal axis coaxial with a longitudinal axis of the filament;
wherein the photonic crystal has a structure configured to reflect at least a portion of wavelengths from an infrared spectrum and to transmit wavelengths from at least a portion of a visible spectrum.

3. The photonic crystal incandescent light source of claim 2 wherein the photonic crystal has a structure comprising layers alternating in a radial direction from the longitudinal axis of the filament, the alternating layers having a periodic difference in refractive indices, causing the photonic crystal to reflect wavelengths from at least a portion of the infrared spectrum and transmit wavelengths from at least a portion of the visible spectrum.

4. The photonic crystal incandescent light source of claim 1, further comprising:
a transparent or translucent envelope housing the filament and the photonic crystal.

5. A method for manufacturing a photonic crystal light source comprising:
a photonic crystal having a structure configured to reflect wavelengths from at least a portion of an infrared spectrum; and
an incandescent central filament in the photonic crystal, causing the photonic crystal to transmit wavelengths from at least a portion of a visible spectrum;
wherein the light source emits at least a portion of visible wavelengths and suppresses emission of at least a portion of infrared wavelengths.
the method comprising the steps of:
providing the filament; and
forming the photonic crystal over the filament.

6. The method of claim 5 wherein forming the photonic crystal layer comprises:
forming a substantially planar flexible photonic crystal film; and
arranging the film to substantially surround the filament to form the photonic crystal with the longitudinal axis of the photonic crystal being coaxial with the longitudinal axis of the central filament.

7. A method of manufacturing a photonic crystal incandescent light source comprising:
providing a light source comprising;
a photonic crystal having a structure configured to reflect wavelengths from at least a portion of an infrared spectrum; and
an incandescent central filament in the photonic crystal, causing the photonic crystal to transmit wavelengths from at least a portion of a visible spectrum;
wherein the light source emits at least a portion of visible wavelengths and suppresses emission of at least a portion of infrared wavelengths;
providing a transparent or translucent envelope; and
mounting opposing ends of the filament within the envelope.

8. The method of claim 7 further comprising the step of:
providing the envelope with a photonic crystal coating, the photonic crystal coating being designed to reflect infrared wavelengths.

9. The method of claim 7 further comprising the step of:
providing the envelope with a photocatalytic coating that provides the light source with at least one of air sterilization, air purification, and odour removal capabilities.

10. The method of claim 9 wherein the photocatalytic coating comprises a photonic crystal.

11. The photonic crystal incandescent light source of claim 2, further comprising:
a transparent or translucent envelope housing the filament and the photonic crystal.

12. A method for manufacturing the photonic crystal light source of claim 2 comprising the steps of:
providing the filament; and
forming the photonic crystal over the filament.

13. The method of claim 12 wherein forming the photonic crystal layer comprises:
forming a substantially planar flexible photonic crystal film; and
arranging the film to substantially surround the filament to form the photonic crystal with the longitudinal axis of the photonic crystal being coaxial with the longitudinal axis of the central filament.
